(19) United States
(12) Patent Application Publication
(10) Pub. No.: US 2005/0216253 A1
(43) Pub. Date: Sep. 29, 2005

(54) System and method for reverse transliteration using statistical alignment

(75) Inventor: Christopher Brockett, Bellevue, WA (US)

Correspondence Address: MICROSOFT CORPORATION C/O WESTMAN;CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Microsoft Corporation, Redmond, WA (US)

(21) Appl. No.: 10/811,273

(22) Filed: Mar. 25, 2004

(51) Int. Cl. G06F 17/28

(52) U.S. Cl. 704/5

(57) ABSTRACT

The present invention obtains a set of word pairs. Each word of the set of word pairs is broken into its component characters, or clusters of commonly co-occurring characters, and using a conventional statistical machine translation algorithm, transliteration models are generated. The transliteration models are used to obtain correct spellings of original language source words from a transliterated form.

### BACKGROUND OF THE INVENTION

The present invention relates to language processing systems. More specifically, the present invention relates to obtaining the original word or words of a first language having a transliteration of the word or words in a second language.

Translation of proper names is generally recognized as a significant problem in many multi-lingual text and speech processing applications. Commonly, when foreign names are used in a different language, the pronunciation of the name is modified. In other words, when a speaker reads a foreign name in his own language, the name is recast according to the sounds of that language so that it sounds different from the name pronounced in the original language. The name may then be rendered into the script in which the speaker's language is written. This process is referred to as transliteration.

Reverse transliteration is a process used to recover an original form of a word such as a name or a technical term from a transliterated form in a foreign language. When English proper names and common nouns are transliterated into non-Latin scripts used in languages such as Japanese, Thai, Arabic or Russian, the identities of these words are often transformed in ways that makes it difficult to recover the original forms. For example, in Japanese the syllabic katakana script neutralizes consonants and inserts vowels, while in Arabic lack of vowel marking may obscure the source form in other ways. Other combinations of languages have similar problems. The transliteration process thus creates major problems for translation in both human and machine, for multi-lingual information retrieval systems to name just one example. Specifically, if an information retrieval system has only a transliterated form of a name of a person, but there is a desire to search text in the original language, a proper reverse transliteration to the original form is needed. For example, an English name such as “Rawding,” might be rendered into Japanese by “ [symbol] ” characters that might be directly transliterated into Latin script under one conventional transliteration scheme as “ro-o-di-n-gu.” This transliteration will not produce any useful results if used to construct a query. A person trying to identify the correct English spelling of name might need to know that “Lawding,” “Lowding,” “Rowding,” and “Rawding,” are all possible original forms in order to finally make the correct identification on the basis of the Japanese. Accordingly, a method and/or system to accurately provide a process of reverse transliteration would be helpful.

### SUMMARY OF THE INVENTION

A first aspect of the present invention obtains a set of word pairs. Each word of the set of word pairs is broken into its component characters, or clusters of commonly co-occurring characters, and using a conventional statistical machine translation algorithm, transliteration models are generated.

In one embodiment, the word pairs are selected from a set of aligned sentences using a text alignment component. The text alignment component selects the word pairs using conventional machine translation algorithms. In a further embodiment, the transliteration models are used to obtain further word pairs from the aligned sentences using a boot strapping technique. In another embodiment, the word pairs may be obtained directly from a preexisting list of words in the two languages, such as a dictionary.

In accordance with another embodiment of the present invention, a decoding algorithm is used to generate at least one transliteration given an input text and using the alignment models output by the alignment system. In a further embodiment, the decoding algorithm provides a set of transliterations for the input text ranked relative to probability.

### BRIEF DESCRIPTION OF THE DRAWINGS

FIG. 1 is a block diagram of one embodiment of an environment in which the present invention can be used.

FIG. 2 is a block diagram of a system for creating a textual-based, transliteration model in accordance with one embodiment of the present invention.

FIG. 2A illustrates using the transliteration model as a feedback component to select sentences for use in training.

FIG. 3 is a flow chart illustrating the operation of the system shown in FIG. 2.

FIG. 4 pictorially illustrates an exemplary mapping between a Japanese word and an English word that has been learned under one embodiment of the system.

FIG. 4A pictorially illustrate an exemplary mapping between a Japanese word and an English word, that has been learned under one embodiment of the system, where the word forms are significantly morphologically different.

FIG. 5 illustrates a sample of generated output produced under one embodiment of the system.

### DETAILED DESCRIPTION OF ILLUSTRATIVE EMBODIMENTS

One aspect of the present invention relates to a system and method using machine translation techniques to build a model for reverse transliteration based on textual or character alignment. However, prior to discussing the present invention in greater detail, one illustrative environment in which the present invention can be used will be discussed.

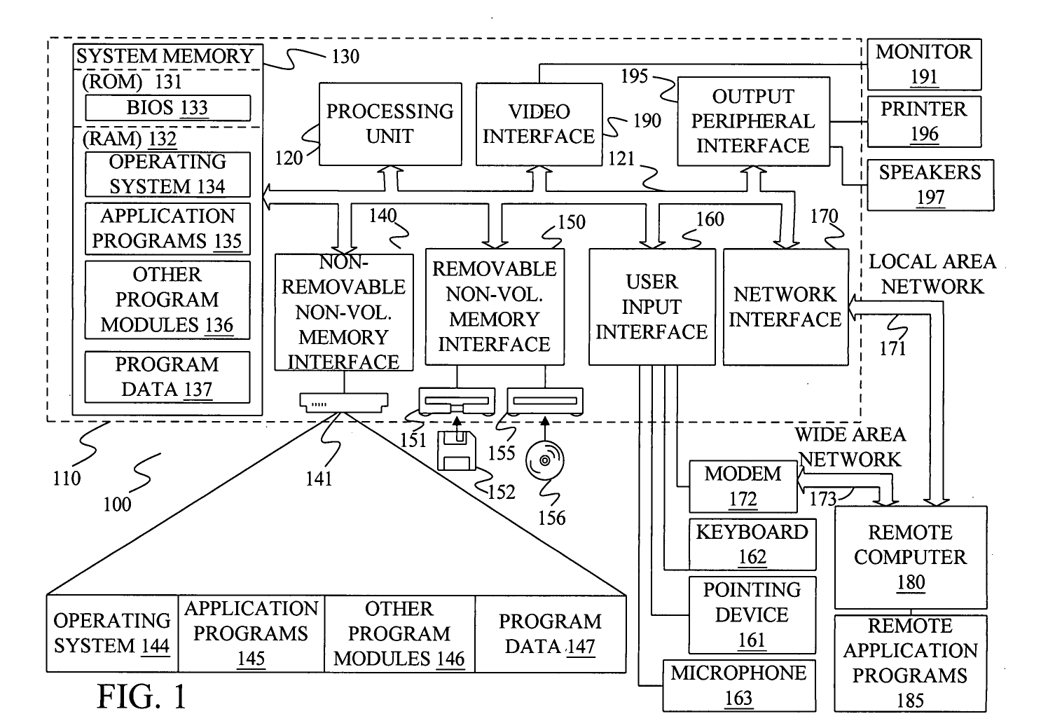

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. Those skilled in the art can implement the description and/or figures herein as computer-executable instructions, which can be embodied on any form of computer readable media discussed below.

The invention may also be practiced in distributed computing environments where tasks are performed by remote processing devices that are linked through a communications network. In a distributed computing environment, program modules may be located in both locale and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a locale bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or other data in a modulated data signal such as a carrier WAV or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way o example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a locale area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that the present invention can be carried out on a computer system such as that described with respect to FIG. 1. However, the present invention can be carried out on a server, a computer devoted to message handling, or on a distributed system in which different portions of the present invention are carried out on different parts of the distributed computing system.

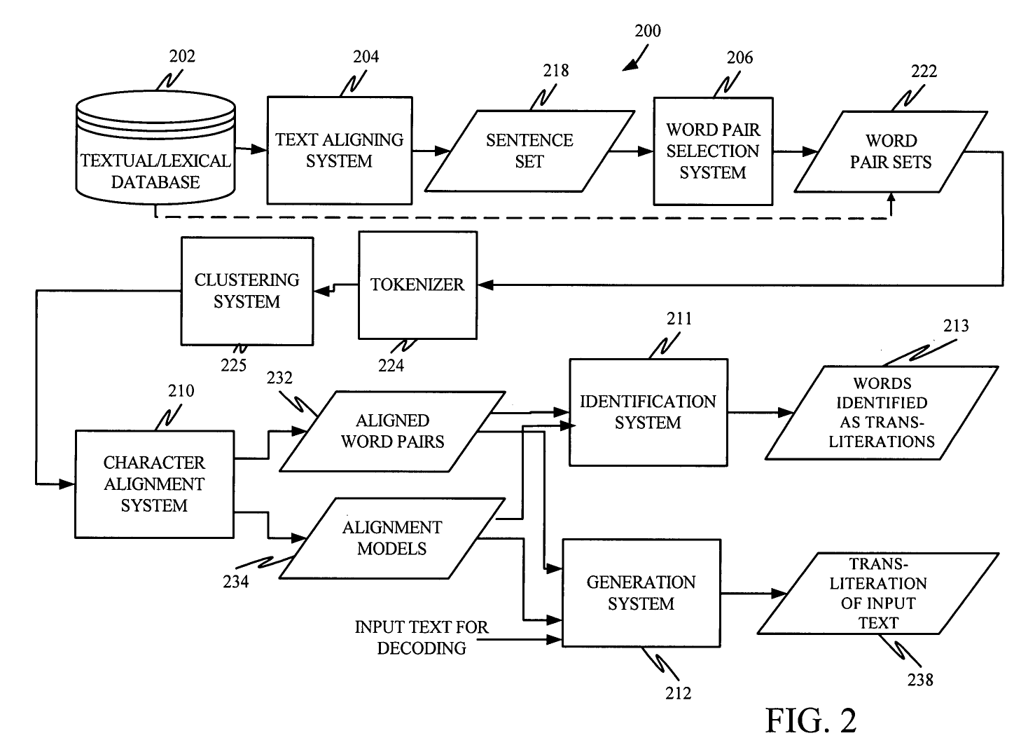

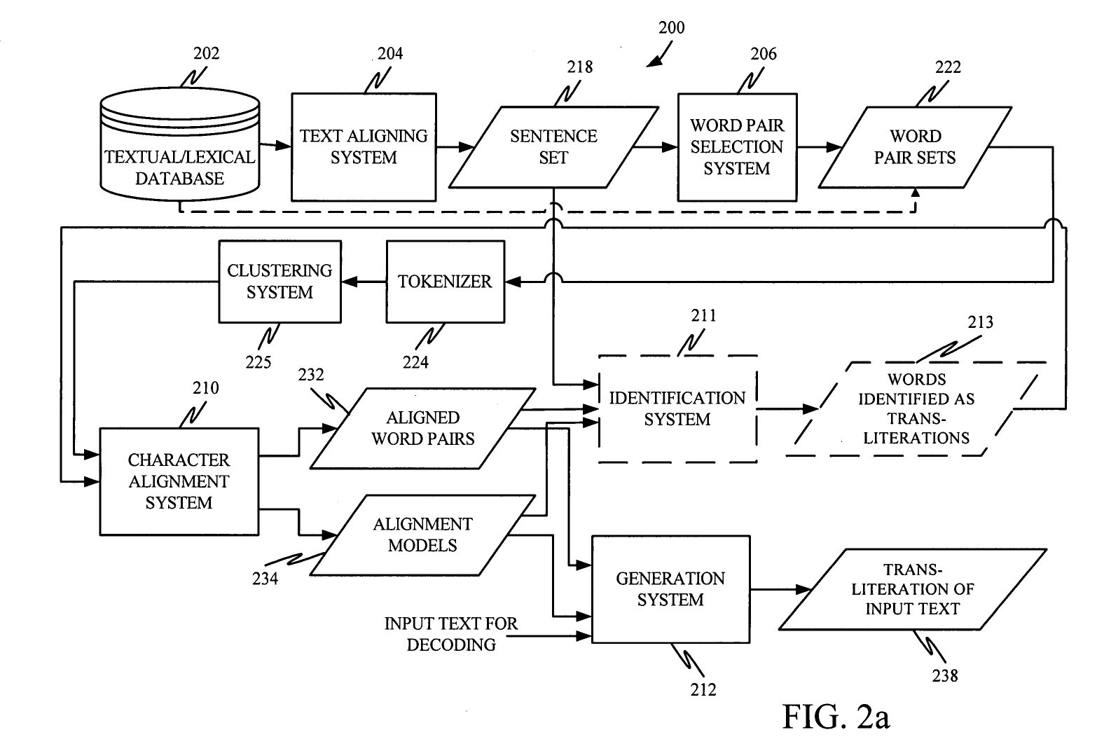

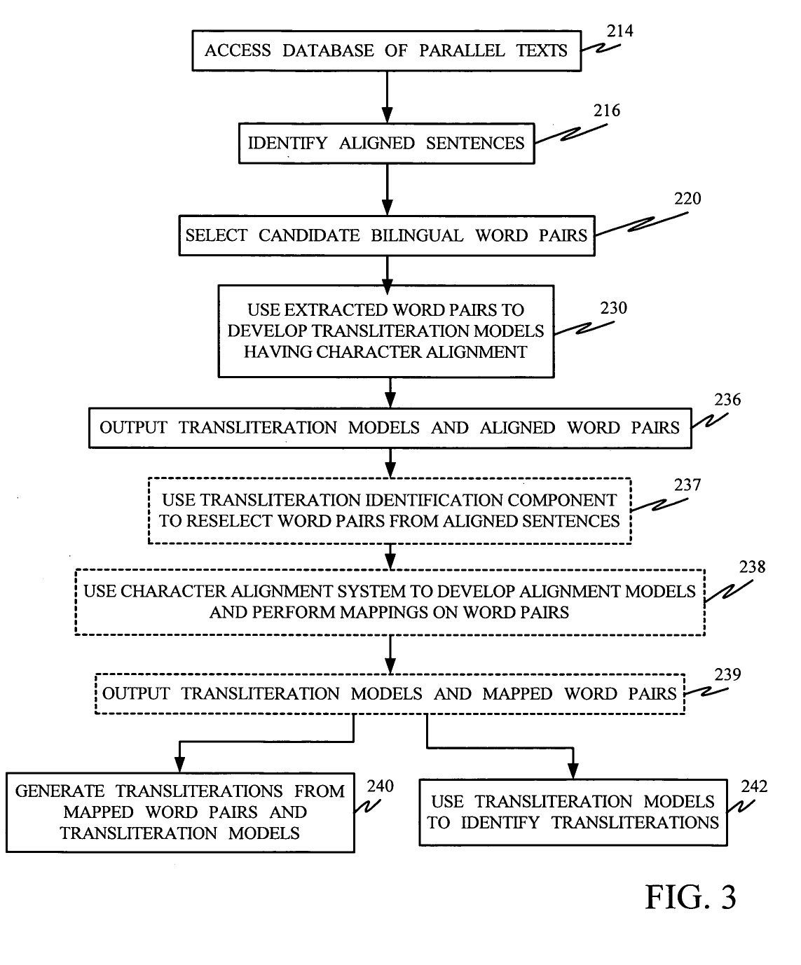

FIG. 2 is a block diagram of one embodiment of a reverse transliteration processing system 200. System 200 has access to a database 202 and includes an optional text aligning system 204 and word pair selection system 206, and character alignment system 210, identification system 211 and generation system 212. FIG. 3 is a flow diagram illustrating the operation of system 200 shown in FIG. 2.

Generally, database 202 includes directly or indirectly word pairs from at least two languages for purposes of performing transliteration. As such the database 202 can comprise or include a dictionary, or be extracted, as generally described below, from parallel texts using standard statistical mapping techniques.

In one embodiment, the database 202 includes parallel texts having, for example, many examples of named entities such as proper names, locations, etc. or technical terms borrowed from another language. In one exemplary embodiment it is assumed that the named entities or other terms are detectable in the texts by script type, such as but not limited to by being written in the katakana script in Japanese, or by other features such as capitalization in English, or by the use of models or systems designed to detect such forms in each language, including, for example, bootstrapping by the present system, employing a preexisting bilingual dictionary as a seed.

Assuming that word pairs must be derived from database 202, text aligning system 204 accesses database 202 as illustrated by block 214 in FIG. 3. It should also be noted that while a single database 202 is illustrated in FIG. 2, a plurality of databases could be accessed instead.

Text aligning system 204 identifies sentences that are equivalent. The sentences identified as being equivalent form a sentence set 218. This is indicated by block 216 in FIG. 3. However, it should be noted that while the present discussion proceeds with respect to sentences, this is only exemplary and other text segments could just as easily be used. Accordingly, “sentences,” as used herein, are considered text segments of any length.

Once related equivalent sentences are identified as a set 218, desired, bilingual word pairs in those sentences are extracted at block 220 by word pair selection system 206. Word pair selection system 206 can extract word pairs using standard statistical mapping techniques. In one illustrative embodiment, word pair selection system 206 is implemented using techniques set out in P. F. Brown et al., The Mathematics of Statistical Machine Translation: Parameter Estimation, Computational Linguistics, 19:263-312, (June 1993). Of course, other statistical machine translation or word alignment techniques can be used for identifying associations between words.

If database 202 comprises a sufficiently large preexisting bilingual dictionary of related word pairs, for example, named entities such as proper names, locations, etc., or technical terms borrowed from another language, the steps in 204, 218, and 206 may be omitted.

Each of the words in word pair set 222 is operated on, if necessary, by tokenizer 224 in order to segment the word into component characters, or sequences of frequently co-occurring characters, for example, the English letter sequence “qu”, in each respective word, where “characters” as used herein is to include all component parts of words used in any language, e.g. English, Japanese, Chinese, Arabic, etc. A clustering system 225 can optionally operate on the word pair sets 222 to provide hierarchical clustering of characters. This benefits the system by boosting probabilities of alignments when characters have similar contextual associations. An exemplary clustering algorithm (JCLUSTER) is available at http://www.research.microsoft.com/research/downloads/, although many other clustering algorithms can be used. In any case, the word pair sets 222 are provided to character alignment system 210.

In one illustrative embodiment, the character alignment system 210 implements the concepts of a conventional word alignment algorithm from the statistical machine translation literature to learn correspondences between the characters in sets 222, applying the concepts of the word alignment algorithm to characters and character sequences instead of words and word sequences. For instance, words are segmented (tokenized) into constituent characters, instead of sentences being tokenized into words.

In one illustrative embodiment, character alignment system 210 is implemented using techniques set out in P. F. Brown et al., The Mathematics of Statistical Machine Translation: Parameter Estimation, Computational Linguistics, 19:263-312, (June 1993). Of course, the concepts of other machine translation or word alignment techniques can be applied to identify associations between characters and character sequences. Unlike prior art reverse transliteration systems that require phonological or pronunciation information, the present system is preferably based exclusively on alignment between characters and character sequences.

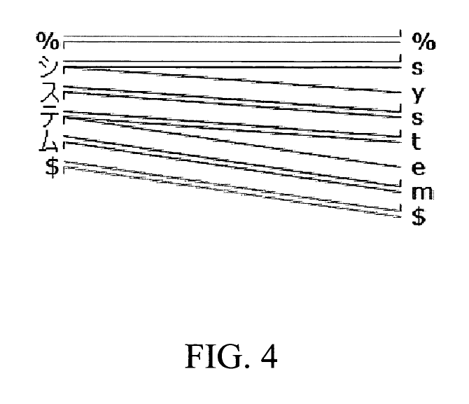

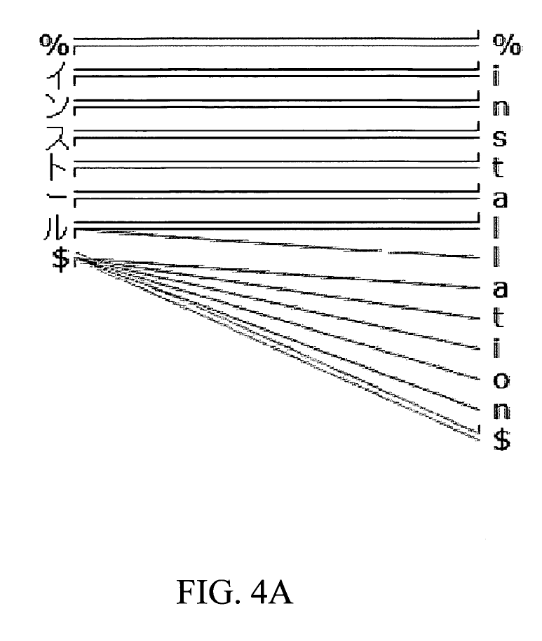

This offers several advantages. For example, it permits the system to be used between language pairs for which phonological data may not exist, or when phonological information is not available, for example, Arabic or Chinese names when encountered in Japanese, but which need to be identified in English. Furthermore, because alignment system 210 uses standard machine translation techniques, the direction of mapping is completely and immediately reversable, allowing the relationship between the languages to be reversed with the same training data. A further advantage of the machine translation modeling over simple character correspondence of word pairs or phonological models is the ability to map characters to null characters; among other things, this permits the system to be relatively robust when confronted with noisy morphological variation between the two languages as might be encountered when data is extracted from parallel texts. For example, given a Japanese katakana form “ [symbol] ” that can be directly transliterated under one conventional transliteration scheme as “ma-ne-e-ji”, the alignment system 210 can learn that these characters map to the English word “managed” in certain contexts, e.g., English “managed code”, despite the additional “-ed” which lacks any counterpart in the Japanese; likewise, the system is able to learn the relevant alignments between the characters in the Japanese word “ [symbol] ”, directly transliterated under one conventional transliteration scheme as “i-n-su-to-o-ru” and English “installation”. FIG. 4A pictorially illustrates the alignments for this latter word pair, learned under one embodiment of the system. In this example, several characters in the English word, namely those in the final character sequence “a-t-i-o-n-$”, are aligned to the Japanese end-token “$”, allowing this English sequence to be potentially available to a cognate word identification system such as that in 211, albeit with a lower likelihood. This robustness, inherited from statistical machine translation, permits alignment system 210 to learn contextual mappings directly from ordinary parallel text data, something that phonological systems cannot do.

By using the full power of a statistical machine translation system, alignment system 210 is able to take advantage of the cascading effects of the algorithms in such a system. In this respect, the model here is different from simple probabilistic models, in that it allows the full panoply of statistical machine translation tools to be applied to learn contextual alignments. Although individual steps within the machine translation system may be omitted in some implementations, the resulting outputs are likely to be suboptimal in the general case. A further advantage is that because the alignment algorithm in 210 is identical with that used in a statistical machine translation system, no additional core alignment code is necessary if such a system is already available; the only modification needed is to require that the input take the form of sequences of characters rather than sequences of words. As appreciated by those skilled in the art, any improvement to the statistical machine translation algorithms may be expected to be translated directly to improvements in alignment algorithm 210. Using an alignment system 210 to develop alignment models and perform statistical character alignment on word pair sets 222 is indicated by block 230 in FIG. 3.

Character alignment system 210 then outputs the aligned word pairs 232 along with the alignment models 234 which it has generated based on the input data. Basically, in the above-cited alignment system, models are trained to identify correspondences between characters or character sequences. The alignment technique first finds character alignments between words. Next, the system assigns a probability to each of the alignments and optimizes the probabilities based on subsequent training data to generate more accurate models on the basis of the contexts supplied by the neighboring characters. Outputting the alignment (transliteration) models 234 and the aligned word pairs 232 is illustrated by block 236 in FIG. 3. A sample word pair showing correct character mappings produced by such alignment system 210 is shown in FIG. 4

The alignment models 234 illustratively include conventional translation model parameters such as the translation probabilities assigned to character alignments and a fertility probability indicative of a likelihood or probability that a single character can correspond to two or more different characters in another word.

Blocks 237, 238 and 239 are optional processing steps used in bootstrapping the system for training itself. They are described in greater detail below with respect to FIG. 2A.

In the embodiment in which bootstrapping is not used, identification system 211 receives the output of character alignment system 210 and identifies words that are transliterations of one another. The identified transliterations 213 are output by identification system 211. This is indicated by block 242 in FIG. 3.

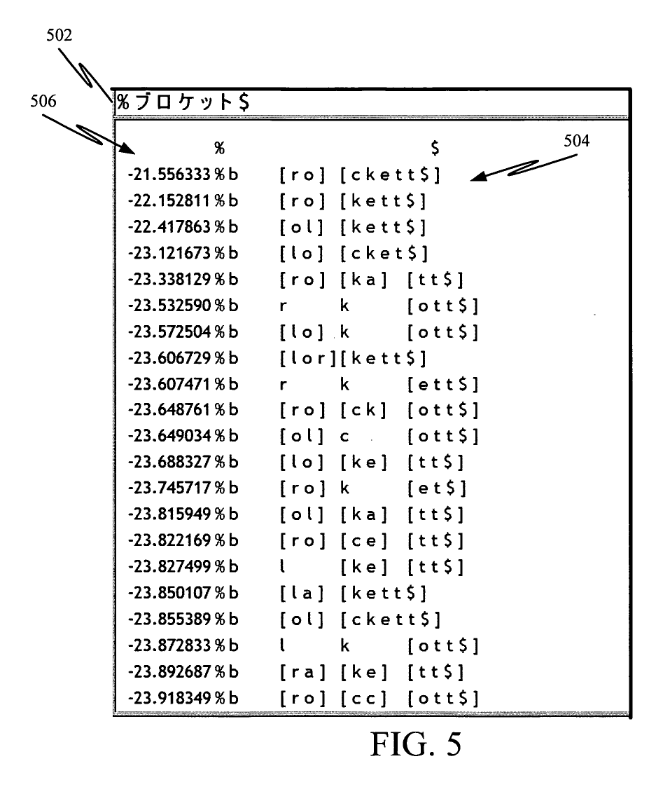

The aligned word pairs and models can also be provided to generation system 212. Generation system 212 is illustratively a conventional decoder that receives, as an input, words and generates, in part, a transliteration 238 for that input. Thus, generation system 212 can be used to generate transliterations of input text using the aligned word pairs 232 and the alignment models 234 generated by alignment system 210. Generating transliterations for input text based on the aligned word pairs and the alignment models is indicated by block 240 in FIG. 3. Again, the same codebase can be used for machine translation and reverse transliteration, providing contextualized transliterations on the basis of a target-language model of character sequences instead of word sequences. One illustrative generation system is set out in Y. Wang and A. Waibel, Decoding Algorithm in Statistical Machine Translation, Proceedings of 35^{th} Annual Meeting of the Association of Computational Linguistics (1997). Commonly, the generation system or decoder generates a best ranked list. Such a list can optionally be further refined or reranked by a variety of methods appropriate to the objective for which reverse transliteration is sought, as exemplified by, but not limited to, submission of the generated candidate words to a spelling checker; verifying the generated candidate words against a list of names, for example, a census list; or formulating web queries to determine the most appropriate candidate, to name just a few. FIG. 5 illustrates a sample ranked list for an English name that is not contained among the word pairs submitted to character alignment system 210 for training. In this example, the input is provided in Japanese indicated at 502, while possible candidates are listed in column 504 and relative ranking of each candidate listed in column 506. Here the best and correct English solution is indicated at the top of column 504.

FIG. 2A is similar to FIG. 2 except that identification system 211 is also used to bootstrap training. This is further illustrated by blocks 237-239 in FIG. 3. For instance, assume that character alignment system 210 has output alignment models 234 and aligned word pairs 232 as described above with respect to FIGS. 2 and 3. Now, however, the entire sentence set 218 is fed to identification system 211 for identifying supplementary word pair sets 300 (again, sentences are used by way of example only, and other text segments could be used as well) for use in further training the system. Identification system 211, with alignment models 234 and aligned word pairs 232, can process the sentences in the sentence sets 218 to re-select word pairs 300 from each of the sentences. This is indicated by block 237. The re-selected word pair sets 300 are then provided to character alignment system 210 which generates or recomputes alignment models 234 and aligned word pairs 232 and their associated probability metrics based on the re-selected word pair sets 300. Performing character and word alignment and generating the alignment models and aligned word pairs on the re-selected word pair sets is indicated by blocks 238 and 239 in FIG. 3.

Now, the re-computed alignment models 234 and the new aligned word pairs 232 can again be input into identification system 211 and used by system 211 to again process the sentences in sentence sets 218 to identify new word pair sets. The new word pair sets can again be fed back into character alignment system 210 and the process can be continued to further refine training of the system.

There is a wide variety of applications for reverse transliterations and transliteration models processed using the present system. For example, the transliteration models can be used in many forms of information retrieval. For instance, such a system can use the transliteration generation capability to perform queries on the basis of one or more candidate words, allowing the user to select the most relevant results. A further application in information retrieval is “sounds-like” queries in which the user's own language writing system is used to construct queries in another language, for example, a Japanese user who using katakana script to construct a query in English, or to simultaneously query Japanese and English data using his or her native language.

In another application, the system might be used as a component of an “intelligent” writing assistance application for non-native speakers of English (or other language). In this case, it might be used to point the speaker to the correct English (or other language) spelling of a word, on the basis of input in the writing system of the speaker's own language.

In yet another application, the system might be used a component of an automated glossing application to assist reading of a foreign language word, by allowing for example a user to place a computer cursor over a word on a web page or other document to pop up a translation. In this application, the system would supplement existing bilingual lexical lookup or machine translation by providing the additional functionality of identifying candidate proper names and other terms that are not in a dictionary

In another application, the system might be used as a component of an input mode editor for entering text language such as Japanese into a computer. In this case, the system would permit users to type a word in the script of their own language and find candidate terms in English or another language that they can select to enter on a page. Such systems are already commercially available, for example the Microsoft IME Standard 2002; here too, this system would supplement existing lookup in a bilingual dictionary with the additional functionality of identifying or proposing candidate proper names and other terms that are not found in the dictionary.

The system has potential application in multiple aspects of machine translation systems. For example, it could be employed to assist in word alignment by identifying proper names and other terms that exist in parallel corpora, as indicated by the identification system 211. The system could further be deployed at machine translation runtime to generate candidate outputs when the system encounters unknown words that for various reasons analysis reveals to be probable borrowings from other languages. In essence, the system can be applied at any point in a machine translation system at which it might be necessary to compare two words or to hypothesize the form of an unknown word of probable foreign origin.

In another application, the system might be deployed as a component of an application for a tool to assist human translators, such as a translation memory tool; in this case, the system would supplement the application's functionality by offering the translator candidate terms, such as the names of people or organizations, or terminology, for decision by the translator.

Although the present invention has been described with reference to particular embodiments, workers skilled in the art will recognize that changes may be made in form and detail without departing from the spirit and scope of the invention.

1. A method of training a transliteration processing system, comprising:
receiving a set of word pairs from different languages; and
using statistical textual alignment to align characters of each of the word pairs; and
identifying the transliteration relationships based on the aligned characters.

2. The method of claim 1 wherein receiving a set of word pairs from different languages comprises:
using statistical textual alignment to align words in parallel sentences to form a set.

3. The method of claim 2 wherein receiving a set of word pairs from different languages comprises:
identifying aligned word pairs from the set of sentences.

4. The method of claim 3 and further comprising:
using the transliteration relationships to identify additional word pairs from the set of sentences.

5. The method of claim 1 and further comprising:
calculating an alignment model based on the transliteration relationships identified.

6. The method of claim 5 and further comprising:
receiving an input text; and
generating a transliteration of the input text based on the alignment model.

7. The method of claim 5 wherein calculating the alignment model based on the transliteration relationships identified includes using the context supplied by neighboring characters.

8. A transliteration processing system, comprising
a textual alignment component configured to receive a set of sentences and identify transliteration relationships between words in the set of words based on alignment of characters of the words.

9. The transliteration processing system of claim 8 wherein the textual alignment component is configured to generate an alignment model based on statistical alignment of the characters of the words.

10. The transliteration processing system of claim 9 wherein the textual alignment component is configured to generate the alignment model based on statistical alignment of the characters of the words including using the context supplied by neighboring characters.

11. The transliteration processing system of claim 8 and further comprising:
a text aligning component configured to access a database and align sentences of parallel texts.

12. The transliteration processing system of claim 11 and further comprising:
a data store storing the database.

13. The transliteration processing system of claim 12 wherein the data store is implemented in one or more data stores.

14. The transliteration processing system of claim 8 and further comprising:
a transliteration generator, receiving a textual input and generating a transliteration of the textual input based on the transliteration relationships.

15. A transliteration processing system, comprising:
a transliteration generator receiving a textual input and generating a transliteration of the textual input based on a transliteration relationship received from a textual alignment component configured to receive a set of sentences and identify transliteration relationships between words in the set of sentences based on statistical alignment of characters in the words in the form of machine translation models.
